(19) United States
(12) Patent Application Publication
(10) Pub. No.: US 2007/0113883 A1
(43) Pub. Date: May 24, 2007

(54) Sunbeams concentration lenses, process and apparatus for solar photovoltaic generator using concept of superposition

(76) Inventors: Jin-Geun Rhee, Daejeon (KR); Kwang-Sun Yoo, Daejon (KR)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/496,731

(22) Filed: Jul. 31, 2006

(30) Foreign Application Priority Data
Nov. 24, 2005 (KR) 10 2005 0113028

(51) Int. Cl. H02N 6/00

(52) U.S. Cl. 136/246

(57) ABSTRACT

The present invention provides a concentration method of sunbeams for a photovoltaic power generation and lens and apparatus used in the method. A method of concentrating sunbeams according to the present invention is characterized in that as a method of concentrating sunbeams on a concentration surface of a solar cell that is installed on a photovoltaic power generator, it comprises steps of installing a concentration lens (20) on the upper side of a solar cell in parallel to the concentration surface, which includes a plurality of unit lens (21) having areas corresponding to the areas of the concentration surface, and irradiating and concentrating superposingly the sunbeams incident on the respective unit lens to the concentration surface. As a result, the present invention has advantageously a best performance in a solar cell.

The present application claims priority under 35 U.S.C. §119 to Korean Patent Application No. 10 2005 0113028, filed 24 Nov. 2005, a certified copy of which is filed herewith and which is hereby incorporated herein by reference as if fully set forth in its entirety.

### BACKGROUND OF THE INVENTION

1. Field of the Invention

The present invention relates to a concentration method of sunbeams for a photovoltaic power generation and lens used in the above method.

2. Background of the Related Art

Generally, a photovoltaic power generation refers to as a technology that converts light energy from the sunbeams into electrical energy using a solar cell. That is, if a solar cell consisting of a PN junction semiconductor is irradiated with sunbeams, it creates free electrons to induce electricity.

Meanwhile, a concentration means such as a concentration lens or a concentration reflection mirror for concentrating sunbeams into a concentration surface of a solar cell is used in a photovoltaic power generation, and a light-integrity and luminance uniformity are related directly to an efficiency of a power plant. However, it has a problem in that a conventional concentration means maintains hardly luminance uniformity on a concentration surface of a solar cell since it uses continuous changes on an optical surface.

FIG. 7 is a view showing an example of a conventional concentration lens, wherein FIG. 7a is a top view and FIG. 7b is a side view. At this time, the concentration lens 30 is fabricated as a Fresnel Lens in a form of a planar plate compared with a conventional convex lens, and a plurality of saw blade-type refraction part 31 are formed on one side thereof, thereby focusing incident lights to the middle.

As a result, the incident sunbeams into the lens are refracted by the saw blade-type refraction part 31 and concentrated into the concentration surface 11 of a solar cell 10 disposed in the middle. However, since the conventional concentration lens as described above focuses the sunbeams using continuous changes on an optical surface, the luminance of the light that is focused on the concentration surface of a solar cell gets lowered gradually from the middle and thus it can not have a uniformity of a luminance.

In addition, if an enlarged sized-concentration lens is needed depending on the power generation capacity, there arises a problem in that it is not fabricated easily since the optical surface of the concentration lens is formed continuously.

Meanwhile, the solar cell that is used in photovoltaic power generation includes a plurality of unit cells which are disposed in series or in parallel for inducing a high power source, and the performance of the photovoltaic power generator is dependent on the unit cell that has a small light irradiation volume among the cells.

Accordingly, if the conventional concentration lens that does not have uniform luminance on the concentration surface is used, there arises another problem in that a total performance of solar cell is decreased with a solar cell that is disposed on the region that has a relatively lower luminance.

### SUMMARY OF THE INVENTION

The present invention has been proposed to solve the above problems, and an object of the present invention is to provide a concentration method of sunbeams for a photovoltaic power generation and lens and apparatus used in the method.

To achieve the above object, according to one aspect of the present invention, it is provided that a method of concentrating sunbeams on a concentration surface of a solar cell that is installed on a photovoltaic power generator, it comprises steps of installing a concentration lens (20) on the upper side of a solar cell in parallel to the concentration surface, which includes a plurality of unit lens (21) having areas corresponding to the areas of the concentration surface, and irradiating and concentrating superposingly the sunbeams incident on the respective unit lens to the concentration surface.

In addition, according to another aspect of the present invention, the a sunbeams concentration lens for a photovoltaic power generation using a concept of superposition including a plurality of unit lenses which are installed in a planar plate shape on the upper side of a solar cell and have areas corresponding to the areas of a concentration surface of the solar cell, wherein the unit lens irradiates the sunbeams incident on them superposingly and concentrates them on the concentration surface.

Meanwhile, according to another aspect of the present invention, the unit lens includes one non-refractive light transmittance part and a plurality of Fresnel lens on one surface of which a plurality of saw blade type-refraction part are formed.

At this time, the light transmittance part is installed on the vertical upper side of the concentration surface and the Fresnel lens is disposed surrounding the light transmittance or extending in opposing directions thereof.

In addition, the saw blade type refraction part of the Fresnel lens is formed in a vertical direction to a straight line running from the Fresnel lens toward the middle of the light transmittance at a predetermined interval, and a inclined angle of the saw blade type refraction part in respective Fresnel lens is decreased gradually from the light transmittance part.

In addition, according to another aspect of the present invention, a sunbeams concentration lens for a photovoltaic power generation includes a plurality of unit lenses which are installed on the upper side of a concentration surface formed on a solar cell and have areas corresponding to the areas of the concentration surface, and the unit lens irradiates the sunbeams incident on them superposingly and concentrates them on the concentration surface, wherein the concentration lens includes one non-refractive light transmittance part that is installed in parallel on the vertical upper side of the concentration surface and a plurality of Fresnel lens extending downside in an opposing direction at a predetermined angle, wherein the inclined angle of the Fresnel lens is set at a range of 10 to 20 degree on the basis of the light transmittance.

Meanwhile, according to another aspect of the present invention, a sunbeams concentration apparatus for a photovoltaic power generation using a concept of superposition includes: a solar cell on one side of which a concentration surface is formed; a concentration lens including a plurality of unit lenses which are installed in a planar plate shape on the upper side of a solar cell and have areas corresponding to the areas of a concentration surface of the solar cell; and a frame that fixes the concentration lens in a proper position, wherein the unit lens irradiates the sunbeams incident on them superposingly and concentrates them on the concentration surface.

In addition, the unit lens includes one non-refractive light transmittance part and a plurality of Fresnel lens on one surface of which a plurality of saw blade type-refraction part are formed.

At this point, the light transmittance part is installed on the vertical upper side of the concentration surface and the Fresnel lens is disposed surrounding the light transmittance or extending in opposing directions thereof.

Meanwhile, the saw blade type refraction part of the Fresnel lens is formed in a vertical direction to a straight line running from the Fresnel lens toward the middle of the light transmittance, and an inclined angle of the saw blade type refraction part in respective Fresnel lens is decreased gradually from the light transmittance part.

In addition, according to another aspect of the present invention, a concentration apparatus for photovoltaic power generation using a concept of superposition includes a solar cell on one side of which a concentration surface is formed; a concentration lens including a plurality of unit lenses which are installed in a planar plate shape on the upper side of a solar cell and have areas corresponding to the areas of a concentration surface of the solar cell; and a frame that fixes the concentration lens in a proper position, wherein the unit lens irradiates the sunbeams incident on them superposingly and concentrates them on the concentration surface, and includes one non-refractive light transmittance part that is installed in parallel on the vertical upper side of the concentration surface and a plurality of Fresnel lens extending downside in the opposing direction of the light transmittance part at a predetermined angle, wherein the inclined angle of the Fresnel lens is set at a range of 10 to 20 degree on the basis of the light transmittance.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention are incorporated, constitute a part of this specifications, and illustrate embodiments of the invention together with the description explaining the principles of the invention. In the drawings:

FIG. 1 is a perspective view showing a concentration apparatus according to a first embodiment of the present invention;

FIG. 2 is a bottom view of FIG. 1;

FIG. 3 is a sectional view taken along A-A line in FIG. 2;

FIG. 4 is a graph showing luminance that is measured on a concentration surface of a solar cell;

FIG. 5 is a perspective view showing a concentration apparatus according to a second embodiment of the present invention;

FIG. 6 is a perspective view showing a concentration apparatus according to a third embodiment of the present invention; and

FIG. 7 is a view showing an example of a conventional concentration lens, wherein FIG. 7a is a top view and FIG. 7b is a side view.

### DETAILED DESCRIPTION OF THE PREFERRED EMBODIMENTS

Reference will now be made in detail to the preferred embodiment of the present invention, examples of which are illustrated in the accompanying drawings.

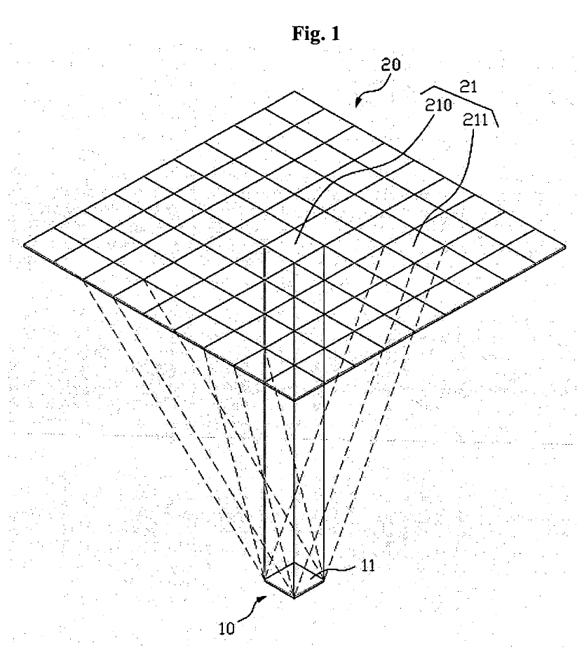

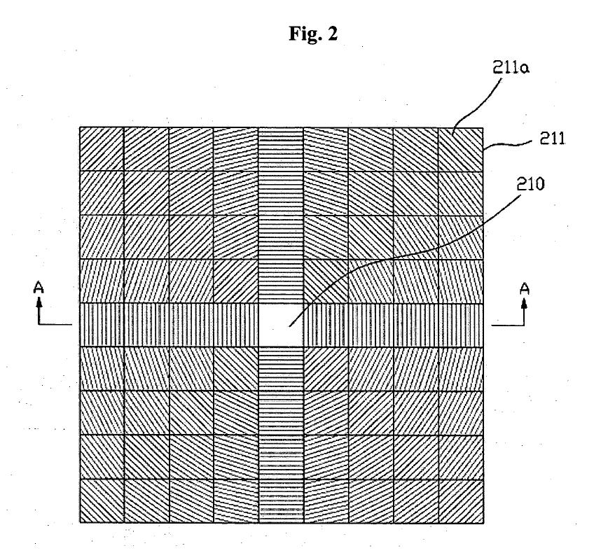

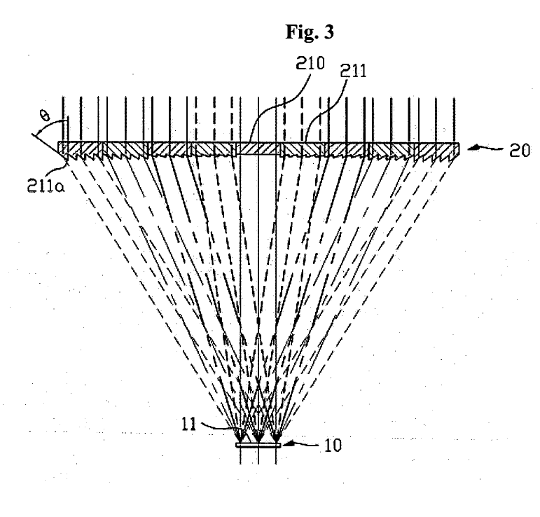

FIG. 1 is a perspective view showing a concentration apparatus according to a first embodiment of the present invention, FIG. 2 is a bottom view of FIG. 1, and FIG. 3 is a sectional view taken along A-A line in FIG. 2.

As shown in drawings, a concentration lens 20 according to one aspect of the present invention is disposed in parallel to the upper surface of a concentration surface 11 formed on a solar cell 20, and it includes a plurality of unit lens 21 the areas of which correspond to the areas of the concentration surface 11. In this embodiment, a total number of 81 unit lens (9×9) is used in forming the concentration lens.

At this time, a respective unit lens 21 is configured to irradiate incident sunbeams therein to the concentration surface 11 of the solar cell 10. Here, respective unit lens 21 irradiates the volume of sunbeams corresponding to the areas of the concentration surface 11 and thus an irradiation amount of sunbeams to the concentration surface 11 is superposed, thereby enhancing light integrity therein compared to the conventional art. In addition, the concentration of the sunbeams is performed using a superposition method instead for a conventional focusing method, thereby gaining a uniform luminance over the entire surface of the concentration surface 11.

In the present embodiment, the unit lens 21 includes a non-refractive light transmittance part 210 that is disposed in the middle of the concentration lens 20 and a plurality of a Fresnel lens 211 which is disposed surrounding the light transmittance part and on one surface of which a plurality of saw blade type-refraction part 211a are formed.

As a result, as shown in FIG. 3, the sunbeams incident on the light transmittance part 210 is transmitted directly and irradiated to the concentration surface 11 of the solar cell 10, and the sunbeam incident on the Fresnel lens 211 is refracted at a predetermined angle by a saw type-refraction part 211a and is irradiated to the concentration surface 11.

At this point, as shown in FIG. 2, the saw type-refraction part 211a that is formed on respective Fresnel lens 211 is formed perpendicular to a straight line of the Fresnel lens 211 to the middle of the light transmittance part 210 at predetermined intervals, and a inclined angle (θ) at respective Fresnel lens is decreased gradually from the light transmittance part 210.

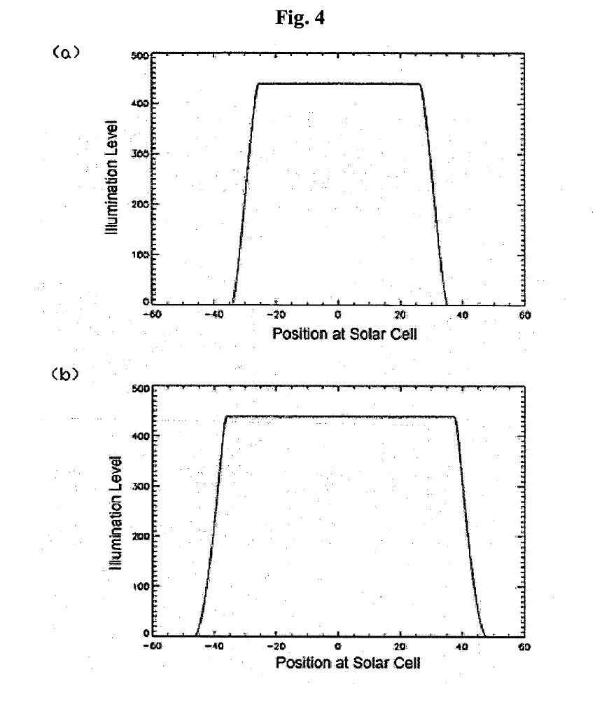

FIG. 4 is a graph showing illuminance that is measured on a concentration surface of a solar cell, wherein (a) shows a illuminance that is measured in a transverse direction and (b) shows a illuminance that is measured in a diagonal direction.

As shown in the graphs on a normal state, if the concentration lens 20 according to the present invention is used, the sunbeams are incident with a uniform luminance over an entire range of the concentration surface 11. That is, if a solar cell is disposed within a normal state line, it can achieve uniform luminance and a large light integration degree.

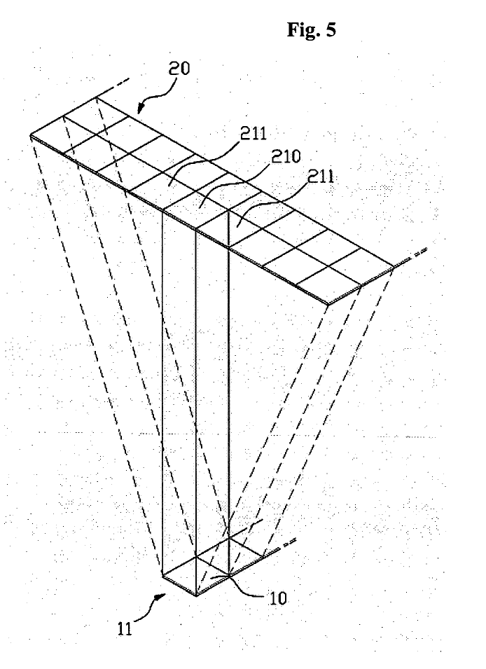

FIG. 5 is a perspective view showing a second embodiment of the present invention. As shown in the drawing, the concentration lens 20 according to the second embodiment of the present invention is characterized in that the light transmittance part 210 is disposed on the vertical upper part of the concentration surface 11 and the Fresnel lens 211 is disposed extending in opposing directions of the light transmittance 210.

That is, the concentration lens as shown in FIG. 1 is installed wherein a Fresnel lens surrounds a light transmittance part and thus if a plurality of solar cell are installed, the spaces which are formed between them can not be narrowed. However, since a concentration lens according to the second embodiment of the present invention is formed as a bar type, solar cells are installed continuously, thereby the more many solar cells can be installed within a limited space.

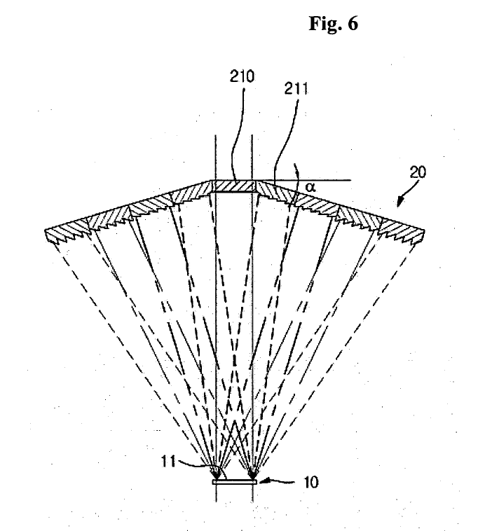

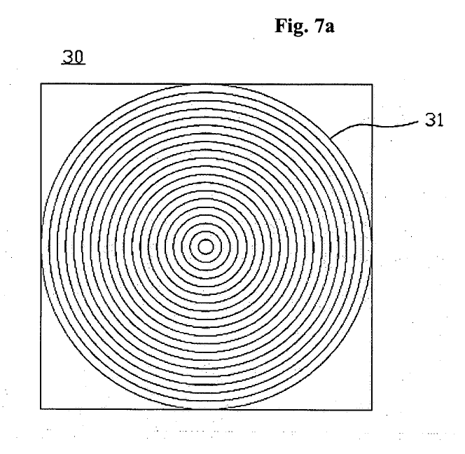

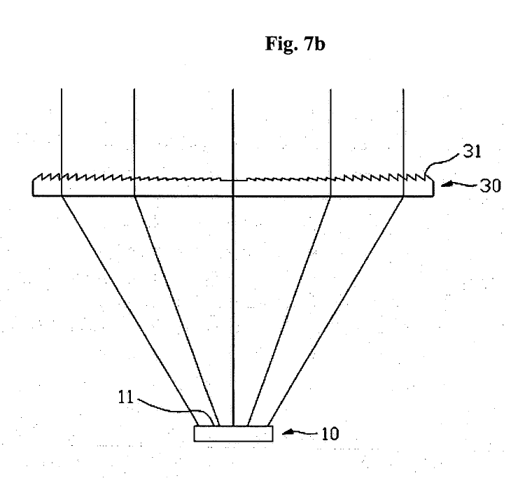

FIG. 6 is a sectional view showing a concentration apparatus according to a third embodiment of the present invention. As shown in the drawing, in the concentration lens 20 according to the third embodiment of the present invention, an inclined angle (α) of the Fresnel lens which is extended in the opposing direction to the light transmittance part 210 as described in the second embodiment is set at a range of 10-20 degree toward downside.

Consequently, a Fresnel lens is installed at a predetermined angle instead of a planar configuration such that a range of receiving sunbeams is enlarged and a light scattering is reduced, thereby improving an efficiency of a concentration.

Since a configuration and an operation of a concentration lens according to the present invention have been explained so far hereinafter a sunbeams concentration method according to the present invention will be explained on the basis of the description thereof.

The sunbeams concentration method of the present invention is characterized in that it comprises steps of installing a concentration lens 20 including a plurality of unit lens 21 having areas corresponding to that of the concentration surface 11 in parallel to the concentration surface 11; and concentrating the sunbeams incident on respective unit lens 21 such that they are irradiated and superposed on the concentration surface 11.

That is, the sunbeams incident on respective unit lens are refracted and irradiated to the concentration surface of the solar cell, and thus the sunbeams on the region corresponding to the areas of the concentration surface are superposed as much as the numbers of unit lens on the concentration surface.

Meanwhile, a concentration unit that is used directly in the concentration method of the present invention is embodied easily using the concentration lens of the present invention. An example of the concentration unit includes a solar cell 10 one side of which is a concentration surface 11, a concentration lens 20 that is installed as a planar plate on the vertical upper side of the concentration surface 11 and a frame (not shown) that fixes the concentration lens 20 in a proper position.

### ADVANTAGEOUS EFFECTS

As described above, according to the preferred embodiments of the present invention, the sunbeams are concentrated on the concentration surface with a superposing pattern as a unit of an area of concentration surface, and thus the sunbeams are irradiated with a uniform luminance over the entire range of the concentration surface. Therefore, a performance of a solar cell is maintained as a best mode compared to the conventional art.

The scope of patents subject matter should not be limited to any of the specific exemplary embodiments discussed, but is instead defined by the following claims. As will be recognized by those skilled in the art, the innovative concepts described in the present application can be modified and varied over a wide range of applications.

1. A sunbeams concentration lens for a photovoltaic power generation using a concept of superposition including a plurality of unit lenses (21) which are installed as a planar plate shape on the upper side of a solar cell (10) and have areas corresponding to the areas of a concentration surface (11) of the solar cell (10), wherein the unit lens (21) irradiates the sunbeams incident on them superposingly and concentrates them on the concentration surface (11).

2. A sunbeams concentration lens for a photovoltaic power generation using a concept of superposition according to claim 1, wherein the unit lens (21) includes one non-refractive light transmittance part (210) and a plurality of Fresnel lens (211) on one surface of which a plurality of saw blade type-refraction part (211a) are formed.

3. A sunbeams concentration lens for a photovoltaic power generation using a concept of superposition according to claim 2, wherein the light transmittance part (210) is installed on the vertical upper side of the concentration surface (11) and the Fresnel lens (211) is disposed surrounding the light transmittance (210).

4. A sunbeams concentration lens for a photovoltaic power generation using a concept of superposition according to claim 2, wherein the light transmittance part (210) is installed on the vertical upper side of the concentration surface (11) and the Fresnel lens (211) is disposed extending in the opposing direction of the light transmittance (210).

5. A sunbeams concentration lens for a photovoltaic power generation using a concept of superposition according to claim 3 4, wherein the saw blade type refraction part (211a) of the Fresnel lens (211) is formed in a vertical direction to a straight line running from the Fresnel lens (211) toward the middle of the light transmittance (210), and a inclined angle (θ) of the saw blade type refraction part (211a) in respective Fresnel lens is decreased gradually from the light transmittance part (210).

6. A sunbeams concentration lens for a photovoltaic power generation using a concept of superposition including a plurality of unit lenses (21) which are installed on the upper side of a concentration surface (11) formed on a solar cell (10) and have areas corresponding to the areas of the concentration surface (11), wherein the unit lens (21) irradiates the sunbeams incident on them superposingly and concentrates them on the concentration surface (11), and includes one non-refractive light transmittance part (210) that is installed in parallel on the vertical upper side of the concentration surface (11) and a plurality of Fresnel lens (211) extending downside in an opposing direction at a predetermined angle (α), wherein the inclined angle (α) of the Fresnel lens (211) is set at a range of 10 to 20 degree on the basis of the light transmittance (210).

7. A method of concentrating sunbeams on a concentration surface (11) of a solar cell (10) that is installed on a photovoltaic power generator comprising steps of:
installing a concentration lens (20) on the upper side of a solar cell in parallel to the concentration surface (11), which includes a plurality of unit lens (21) having areas corresponding to the areas of the concentration surface (11); and
irradiating and concentrating superposingly the sunbeams incident on the respective unit lens (21) to the concentration surface (11).

8. A sunbeams concentration apparatus for a photovoltaic power generation using a concept of superposition comprising:
a solar cell (10) one side of which is a concentration surface (11);
a concentration lens (20) including a plurality of unit lenses (21) which are installed as a planar plate shape on the upper side of a solar cell (10) and have areas corresponding to the areas of a concentration surface (11) of the solar cell (10); and
a frame that fixes the concentration lens (20) in a proper position, wherein the unit lens (21) irradiates the sunbeams incident on them superposingly and concentrates them on the concentration surface (11).

9. A sunbeams concentration apparatus for a photovoltaic power generation using a concept of superposition according to claim 8, wherein the unit lens (21) includes one non-refractive light transmittance part (210) and a plurality of Fresnel lens (211) where a plurality of saw blade type-refraction part (211a) are formed on one surface.

10. A sunbeams concentration apparatus for a photovoltaic power generation using a concept of superposition according to claim 9, wherein the light transmittance part (210) is installed on the vertical upper side of the concentration surface (11) and the Fresnel lens (211) is disposed surrounding the light transmittance (210).

11. A sunbeams concentration apparatus for a photovoltaic power generation using a concept of superposition according to claim 9, wherein the light transmittance part (210) is installed on the vertical upper side of the concentration surface (11) and the Fresnel lens (211) is disposed extending in the opposing direction of the light transmittance (210).

12. A sunbeams concentration apparatus for a photovoltaic power generation using a concept of superposition according to claim 10, wherein the saw blade type refraction part (211a) of the Fresnel lens 211 is formed in a vertical direction to a straight line running from the Fresnel lens (211) toward the middle of the light transmittance (210), and a inclined angle (θ) of the saw blade type refraction part (211a) in respective Fresnel lens is decreased gradually from the light transmittance part (210).

13. A sunbeams concentration apparatus for a photovoltaic power generation using a concept of superposition including: a solar cell (10) where a concentration surface (11) is formed on one side; a concentration lens (20) including a plurality of unit lenses (21) which are installed as a planar plate shape on the upper side of a solar cell (10) and have areas corresponding to the areas of a concentration surface (11) of the solar cell (10); and a frame that fixes the concentration lens (20) in a proper position, wherein the unit lens (21) irradiates the sunbeams incident on them superposingly and concentrates them on the concentration surface (11), and includes one non-refractive light transmittance part (210) that is installed in parallel on the vertical upper side of the concentration surface (11) and a plurality of Fresnel lens (211) extending downside in the opposing direction of the light transmittance part (210) at a predetermined angle (α), wherein the inclined angle (α) of the Fresnel lens (211) is set at a range of 10 to 20 degree on the basis of the light transmittance (210).

14. A sunbeams concentration lens for a photovoltaic power generation using a concept of superposition according to claim 4, wherein the saw blade type refraction part (211a) of the Fresnel lens (211) is formed in a vertical direction to a straight line running from the Fresnel lens (211) toward the middle of the light transmittance (210), and a inclined angle (θ) of the saw blade type refraction part (211a) in respective Fresnel lens is decreased gradually from the light transmittance part (210).

15. A sunbeams concentration apparatus for a photovoltaic power generation using a concept of superposition according to claim 11, wherein the saw blade type refraction part (211a) of the Fresnel lens 211 is formed in a vertical direction to a straight line running from the Fresnel lens (211) toward the middle of the light transmittance (210), and a inclined angle (θ) of the saw blade type refraction part (211a) in respective Fresnel lens is decreased gradually from the light transmittance part (210).
